(19) United States
(12) Patent Application Publication
(10) Pub. No.: US 2023/0042583 A1
(43) Pub. Date: Feb. 9, 2023

(54) MESSAGE EXCHANGE BETWEEN COMPUTING DEVICES OPERABLE TO IMPLEMENT COAP

(71) Applicant: Telefonaktiebolaget LM Ericsson (publ), Stockholm (SE)

(72) Inventor: Oscar NOVO DIAZ, HELSINKI (FI)

(73) Assignee: Telefonaktiebolaget LM Ericsson (publ), Stockholm (SE)

(21) Appl. No.: 17/787,054

(22) PCT Filed: Dec. 20, 2019
(86) PCT No.: PCT/SE2019/051327

§ 371 Date: Jun. 17, 2022

(51) Int. Cl. H04L 1/18; H04L 69/00

(52) U.S. Cl. CPC H04L 1/1883; H04L 69/03; H04L 1/1874

(57) ABSTRACT

An instructing computing device (210) is disclosed that is operable to implement a 5Constrained Application Protocol (CoAP). The computing device comprises processing circuitry configured to send a first message (211) to a target computing device (220), which comprises a first message identifier and store a record (212) of the first message in a memory. The processing circuitry is further configured to receive a second message (223) from the target computing device, the second message confirming that 0the target computing device has received the first message, wherein the first message is configured to cause the target computing device to store a record (222) of the first message.

### TECHNICAL FIELD

The present disclosure relates to instructing and target computing devices operable to implement a Constrained Application Protocol (CoAP). The present disclosure also relates to methods performed by instructing and target computing devices operable to implement CoAP, and to a computer program and a computer program product configured, when run on a computer to carry out methods for operation of instructing and target computing devices operable to implement CoAP.

### BACKGROUND

The “Internet of Things” (IoT) refers to devices, which may include computing devices such as digital machines or mechanical devices, enabled for communication network connectivity, so that these devices may be remotely managed, and data collected or required by the devices may be exchanged between individual devices and between devices and application servers. Such devices, examples of which may include sensors and actuators, are often, although not necessarily, subject to limitations on processing power, storage capacity, energy supply, device complexity and/or network connectivity, imposed by their operating environment or situation, and may consequently be referred to as constrained devices.

The constrained nature of IoT devices has prompted the design and implementation of new protocols and mechanisms. The Constrained Application Protocol (CoAP), as defined in RFC 7252, is one example of a protocol designed for IoT applications in constrained nodes and constrained networks. CoAP provides a request for information-response based RESTful communication architecture between constrained nodes or between constrained nodes and nodes on the Internet. CoAP can easily be integrated with the web and web services by translating CoAP messages to HTTP.

CoAP is designed to be simple, and enables constrained devices to communicate in constrained networks with low bandwidth and low availability. Similar to HTTP, CoAP follows a client/server model and is based on REST (Representational State Transfer) architecture. CoAP is not a replacement for HTTP, but is a new design, which comes with features to accommodate the limitations of HTTP. CoAP employs a two-layer structure, where these two layers are the Message Layer and the Request/Response layer. The Request/Response layer supports methods including GET, PUT, POST and DELETE (as defined in RFC 7252), allowing for the access, modification, or deletion of resources. The Message Layer supports four types of messages: CON (confirmable), NON (non-confirmable), ACK (acknowledgement), and RST (reset), as defined in RFC 7252.

Confirmable messages are sent between a CoAP client and a CoAP server and require acknowledgement of reception by the recipient of the confirmable message. Non-confirmable messages do not require such acknowledgement. An Acknowledgement message is sent in response to a Confirmable message and acknowledges that a specific Confirmable message has been received. By itself, an Acknowledgement message does not indicate success or failure of any Request encapsulated in the Confirmable message, merely that the Confirmable message has been received. However, the Acknowledgement message may carry a Piggybacked Response. A Reset message indicates that a specific message was received, but some context that is required to process the message correctly is missing. This condition may be caused, for example, when a CoAP server has rebooted and deleted a state that is required to interpret the message.

The CoAP standard defines two types of message exchange delivery. The first type is best-effort delivery, where there is no guarantee that a message is received. This type of reliability is achieved using the Non-confirmable message type (NON) according to which the CoAP recipient does not acknowledge receipt of the Non-confirmable message and the CoAP sender does not store and retransmit the message. The second type of message delivery guarantees that a message is delivered to the CoAP recipient, using the Confirmable and Acknowledgement message types. A CoAP sender stores a sent Confirmable message and may resend the stored message until a corresponding Acknowledgment message is received from the CoAP receiver that acknowledges that the Confirmable message was received.

While the second type of message delivery can ensure that a confirmable message (CON) has been received by the CoAP recipient it is possible under the existing procedures that the same Confirmable message may be received and processed by the CoAP receiver multiple times. The sender of a Confirmable message initiates a timer upon transmission of the Confirmable message. If the CoAP sender has not received an Acknowledgement message in response to the Confirmable message before the expiry of the timer, the Confirmable message is retransmitted and the timer is restarted. This process continues until the sender receives an Acknowledgement message (ACK) in response to the Confirmable message.

A CoAP receiver therefore receives a Confirmable message from a CoAP sender, processes the Confirmable message or forwards the confirmable message for processing, and sends an Acknowledgment message in response. If the Acknowledgement message is not correctly delivered to the CoAP sender, the timer of the CoAP sender will expire, and in response to the timer expiring the CoAP sender will resend the Confirmable message until a suitable Acknowledgement message is received. This results in the CoAP receiver receiving the same Confirmable message a duplicate number of times. The CoAP receiver has no means of identifying such duplicate messages, and so will treat each new Confirmable message in accordance with its usual procedures. If the duplicate Confirmable message requests an action, then this can result in the same action being carried out more than once by the CoAP receiver, which may have significant consequences for the IoT system.

Message Queueing Telemetry Transport (MQTT) is another IoT messaging protocol that defines different types of messages for improving the reliability of message exchange between CoAP devices. MQTT is a data centric protocol using a publish/subscribe paradigm. MQTT is event driven, with messages pushed to subscribed client devices. Although MQTT may offer improvements in reliability compared to CoAP, the MQTT and CoAP protocols demonstrate significant differences, both architecturally and in terms of semantics. In addition, MQTT uses the Transmission Control protocol (TCP), which is more reliable that the User Datagram Protocol (UDP) that is used for CoAP. Therefore while in some systems MQTT may offer improvements in message exchange reliability, owing to the architectural and semantic differences between MQTT and CoAP, MQTT may not be a suitable protocol for many systems or at the least may require a prohibitive degree of system redesign.

### SUMMARY

It is an aim of the present disclosure to provide an instructing computing device, target computing device, methods and computer readable medium which at least partially address one or more of the challenges discussed above.

According to a first aspect of the present disclosure, there is provided an instructing computing device operable to implement a Constrained Application Protocol (CoAP), the instructing computing device comprising processing circuitry configured to send a first message to a target computing device, the first message comprising a first message identifier. The processing circuitry is further configured to store a record of the first message in a memory. The processing circuitry is also configured to receive a second message from the target computing device, the second message confirming that the target computing device has received the first message, wherein the first message is configured to cause the target computing device to store a record of the first message.

According to another aspect of the present disclosure, there is provided a target computing device operable to implement CoAP, the target computing device comprising processing circuitry configured to receive a first message from an instructing computing device, the first message comprising a first message identifier and a request. Responsive to receiving the first message, the processing circuitry is further configured to store a record of the first message in a memory and send a second message to the instructing computing device, the second message confirming that the computing device has received the first message.

According to another aspect of the present disclosure, there is provided a method performed by an instructing computing device operable to implement CoAP. The method comprises: sending a first message to a target computing device, the first message comprising a first message identifier, storing a record of the first message in a memory and receiving a second message from the target computing device, the second message confirming that the target computing device has received the first message. The first message is configured to cause the target computing device to store a record of the first message.

According to another aspect of the present disclosure, there is provided a method performed by a target computing device operable to implement CoAP. The method comprises: receiving a first message from an instructing computing device, the first message comprising a first message identifier and a request. Responsive to receiving the first message the method further comprises: storing a record of the first message in a memory and sending a second message to the instructing computing device, the second message confirming that the computing device has received the first message.

The computing device according to aspects of the present disclosure may, in some examples, comprise a constrained device. For the purposes of the present disclosure, a constrained device comprises a device which conforms to the definition set out in section 2.1 of RFC 7228 for “constrained node”.

According to the definition in RFC 7228, a constrained node is a node in which “some of the characteristics that are otherwise pretty much taken for granted for Internet nodes at the time of writing are not attainable, often due to cost constraints and/or physical constraints on characteristics such as size, weight, and available power and energy. The tight limits on power, memory, and processing resources lead to hard upper bounds on state, code space, and processing cycles, making optimization of energy and network bandwidth usage a dominating consideration in all design requirements. Also, some layer-2 services such as full connectivity and broadcast/multicast may be lacking. A constrained device according to examples of the present disclosure is thus clearly distinguished from server systems, desktop, laptop or tablet computers and powerful mobile devices such as smartphones. A constrained device may for example comprise a Machine Type Communication device, a battery powered device or any other device having the above discussed limitations. Examples of constrained devices may include sensors measuring temperature, humidity and gas content, for example within a room or while goods are transported and stored; motion sensors for controlling light bulbs; sensors measuring light that can be used to control shutters; heart rate monitors and other sensors for personal health (continuous monitoring of blood pressure etc.); and actuators including for example connected electronic door locks. A constrained network correspondingly comprises “a network where some of the characteristics pretty much taken for granted with link layers in common use in the Internet at the time of writing are not attainable”, and more generally, may comprise a network comprising one or more constrained devices as defined above.

According to another aspect of the present disclosure, there is provided a computer program comprising instructions which, when executed on at least one processor, cause the at least one processor to carry out a method according to any one of the preceding aspects or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a message flow diagram illustrating an example of a confirmable message exchange as described in RFC 7252 between a CoAP sender and a CoAP receiver;

FIG. 2 is a message flow diagram illustrating an example message exchange between a CoAP sender and a CoAP receiver according to examples of the present disclosure;

FIG. 3 is a flow chart illustrating a method performed by an instructing computing device operable to implement CoAP;

FIGS. 4a and 4b show a flow chart illustrating another method performed by an instructing computing device operable to implement CoAP;

FIG. 5 is a flow chart illustrating a method performed by a target computing device operable to implement CoAP;

FIGS. 6a and 6b show a flow chart illustrating another method performed by a target computing device operable to implement CoAP;

FIG. 7 is a message flow diagram illustrating another example exchange between a CoAP sender and a CoAP receiver;

FIG. 8 is a diagram illustrating an example of a CoAP message;

FIG. 9 is a diagram illustrating an example of a CoAP option format;

FIG. 10 is a table illustrating an example of the CoAP options listed in the CoAP standard;

FIG. 11 is a diagram illustrating an example of a 2-bit CoAP option;

FIG. 12 is a message flow diagram illustrating another example exchange between a CoAP sender and a CoAP receiver;

FIG. 13 is a message flow diagram illustrating another example exchange between a CoAP sender and a CoAP receiver;

FIG. 14 is a message flow diagram illustrating another example exchange between a CoAP sender and a CoAP receiver;

FIG. 15 is a message flow diagram illustrating another example exchange between a CoAP sender and a CoAP receiver;

FIG. 16 is a block diagram illustrating an example of a computing device operable to implement CoAP;

### DETAILED DESCRIPTION

Aspects of the present disclosure relate to improving the reliability of message exchange between an instructing computing device operable to implement CoAP (also referred to as a CoAP sender) and a target computing device operable to implement CoAP (also referred to as a CoAP receiver). The CoAP sender may be a CoAP client and the CoAP receiver may be a CoAP server or vice versa. The following discussion of message exchange using existing Confirmable and Acknowledgement message types provides additional context for the subsequent discussion of message exchanges according to aspects of the present disclosure.

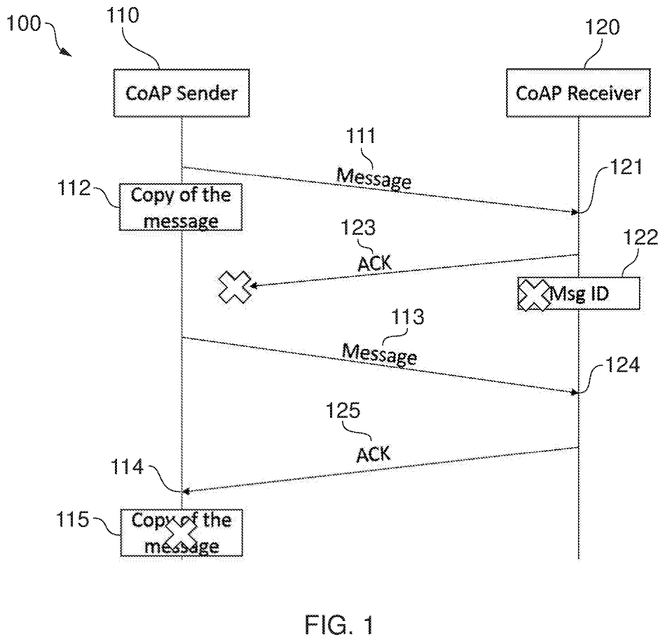

FIG. 1 is a message flow diagram 100 illustrating an example exchange as described in RFC 7252 between a CoAP sender 110 and a CoAP receiver 120 using Confirmable and Acknowledgement message types. In step 111 the CoAP sender 110 sends a Confirmable message to the CoAP receiver 120, the Confirmable message containing for example a message request and including a message identifier. In step 112 the CoAP sender stores a copy of the Confirmable message and initiates a timer. In step 121 the CoAP receiver 120 receives the Confirmable message and processes the received message, for example obtaining requested information or performing a requested action. In step 123 the CoAP receiver sends an Acknowledgment message to CoAP the sender 110. The Acknowledgment message includes the same message identifier as the Confirmable message, allowing the CoAP sender to match the Acknowledgement message to the correct Confirmable message, and may include a piggybacked Response. Having sent the Acknowledgement message, the CoAP receiver then deletes the message ID of the Confirmable message in step 122.

It is possible that the acknowledgment message sent to the CoAP receiver 120 may be lost and may not reach the CoAP sender, as illustrated in FIG. 1. In such circumstances, the timer initiated by the CoAP sender 110 will expire before an Acknowledgment of the Confirmable message sent in step 111 is received. In step 113 the CoAP Sender therefore resends the Confirmable message to the CoAP receiver 120. In step 124, the CoAP receiver 120 receives the resent Confirmable message, processes the resent Confirmable message and, at step 125, sends an Acknowledgment message to the CoAP sender 110. As the CoAP receiver 120 has deleted the message identifier of the original Confirmable message in step 122, the CoAP receiver 120 is unaware that the message received in step 124 is in fact a duplicate of a message that has already been received and processed. The CoAP receiver 120 therefore interprets the resent Confirmable message as a “new” Confirmable message.

In step 114 the CoAP sender receives the Acknowledgment message sent in step 125. Responsive to receiving the Acknowledgment message, in step 115 the CoAP sender 110 deletes the stored copy of the confirmable message and the message exchange between the CoAP sender 110 and CoAP receiver 120 is complete.

FIG. 1 therefore illustrates how a Confirmable message may be received multiple times by a CoAP receiver, without either the sender or receiver being aware that the message has been received more than once. This situation may have significant consequences in certain applications such as mission critical applications or in payment/billing applications, in which duplicate messages may lead to multiple charges being applied to an account. Aspects of the present disclosure seek to address this issue by providing computing devices, methods and a computer program which may ensure that a message sent by a computing device is received and acted upon once and only once.

An overview of behaviour of instructing and target computing devices operable to implement CoAP according to different examples of the present disclosure is provided below, together with discussion of details which may be incorporated in different implementations of these examples. There then follows a discussion of example methods according to the present disclosure, which methods may be implemented by processing circuitry in an instructing or target computing device operable to implement CoAP according to the present disclosure. Some example message sequences are then discussed illustrating operation of an instructing computing device operable to implement CoAP and a target computing device operable to implement CoAP according to examples of the present disclosure. As discussed above, an instructing computing device may be referred to as a CoAP sender, and a target computing device may be referred to a as CoAP receiver. Either of the CoAP sender or receiver may be a CoAP server or a CoAP client. A CoAP server according to examples of the present disclosure is operable to provide information, such as representations, for one or more resources. A resource may for example be a data object or information, a service or application, a sensor etc.

As described above, the CoAP standard (RFC 7252) specifies the Confirmable message type and the Acknowledge message type, which message types provide a degree of reliability that a message sent from a CoAP sender was successfully received by a CoAP receiver. However, the CoAP standard currently does not provide a solution to reliably confirm that a message sent from a CoAP sender to a CoAP receiver was successfully received only once. As described above, if the timer of the sender expires before the Acknowledgment message is received, then the Confirmable message is resent. This can result in the CoAP receiver processing the message a duplicate number of times, which is not tolerable in certain applications.

It is therefore proposed that a new CoAP message exchange mechanism may be provided to address this challenge. The new mechanism proposes four new CoAP messages, which may be implemented as new message types or as Options to be included in existing message types, which Options will modify the behaviour of senders and receivers of such messages. In one example a single new Option may be defined, with four possible values corresponding to the four new messages. In another example, four new Options may be defined, one for each new message. According to examples of the new mechanism, both the CoAP sender (instructing computing device) and CoAP receiver (target computing device) may maintain a record of sent and/or received messages enabling the CoAP sender and CoAP receiver to cooperate such that duplicate messages are detected.

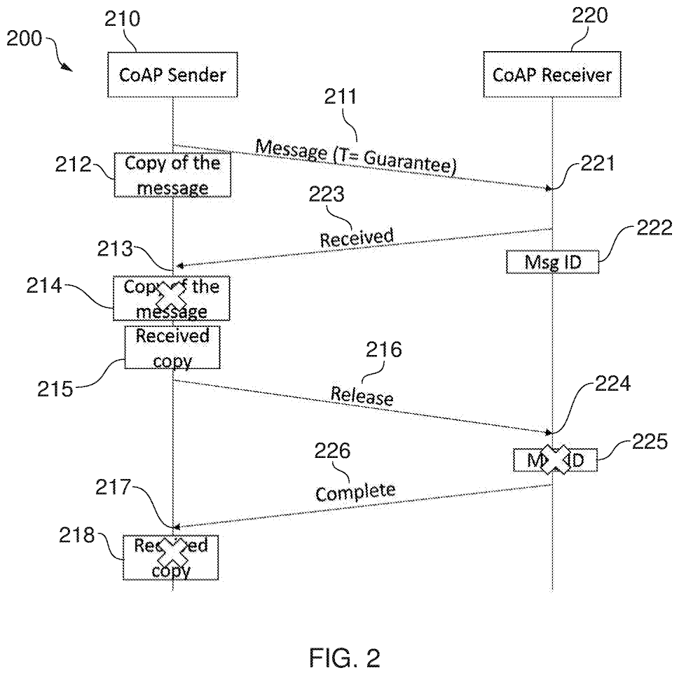

FIG. 2 is a message flow diagram 200 illustrating a message exchange between a CoAP sender 210 and a CoAP receiver 220 according to an example of the present disclosure.

In step 211 the CoAP sender sends a first message to a CoAP receiver 220. The first message may be a new CoAP message which may be termed a “Guarantee message”, as illustrated in FIG. 2. The Guarantee message may be implemented as a new message type “Guarantee”, or in other examples, the Guarantee message may be implemented via a new Option included in a Confirmable message. The Guarantee message comprises a first message identifier and in the illustrated example carries a request for the CoAP receiver 220. The Guarantee message is configured (via its message type or included Option) to cause the CoAP receiver 220 to store a record of the Guarantee message.

The CoAP sender 210 may initiate a first message timer on sending the Guarantee message. Upon expiry of the first message timer, if the CoAP sender 210 has not received a second message, referred to as a “Received” message and described in more detail below, from the CoAP receiver 220, the CoAP sender 210 may resend the Guarantee message to the CoAP receiver 220. The first message timer may be configured substantially in the manner described in RFC 7252 for the message timer corresponding to sending of a Confirmable time message.

In step 212 the CoAP sender 210 stores a record of the Guarantee message in a memory. The record of the CoAP sender 210 may comprise a copy of the Guarantee message. In step 221, the CoAP receiver 220 receives the Guarantee message from the CoAP sender 210, the Guarantee message including its message identifier and the Request. In step 222, the CoAP receiver stores a record of the Guarantee message in a memory of the CoAP receiver 220. As illustrated in FIG. 2, the stored record of the CoAP receiver may comprise at least a part of the message identifier. In step 223, the CoAP receiver 220 sends a second message to the CoAP Sender 210, which may be another new message termed a “Received message”, as illustrated in FIG. 2. As for the Guarantee message, the Received message may be implemented as a new message type “Received” or via a new Option included in an Acknowledgement message. The Received message includes the message identifier from the Guarantee message and confirms that the CoAP receiver 220 has received the Guarantee message.

In some examples, if the new message type “Guarantee” is used and a CoAP receiver 220 implements the CoAP standard as in RFC 7252, but not as described herein, it may respond to the Guarantee message by sending a “4.00 Bad request” response code to the CoAP sender, prompting the CoAP sender to send a conventional Confirmable message. In other examples, if the Guarantee message is implemented using an Option, and the CoAP receiver does not recognise the Option, the CoAP receiver may process the Guarantee message as a conventional Confirmable message.

In some examples, in response to the CoAP receiver 220 sending the Received message, the CoAP receiver 220 may initiate a second message timer. Upon expiry of the second message timer, the CoAP receiver 220 updates the record of the Guarantee message in its memory. Updating may include updating the record to indicate that it is no longer needed, or may include deleting the record form the CoAP receiver's memory. In some examples, upon expiry of the timer, if the CoAP receiver 220 has not received a third message referred to as a “Release” message (described in more detail below) from the CoAP sender 210, the CoAP receiver 220 may resend the Received message to the CoAP sender 210.

In step 213, the CoAP Sender 210 receives the Received message from the CoAP receiver 220. In response to receiving the Received message, the CoAP sender updates its record of the Guarantee message. In the illustrated example of FIG. 2, updating the record of the CoAP Sender comprises deleting its copy of the Guarantee message. In step 215, the CoAP sender 210 stores a copy of the Received message from the CoAP receiver. In step 216, the CoAP sender sends a third message to the CoAP receiver 220, which may be another new message termed a “Release” message, as illustrated in FIG. 2. As for the Guarantee message, the Release message may be implemented as a new message type “Release” or via a new Option included in a Confirmable message. The Release message comprises a second message identifier. The Release message is configured to cause the CoAP receiver 220 to update its record of the Guarantee message to indicate that the Received message, confirming receipt by the CoAP receiver of the Guarantee message, has been received by the CoAP sender 210.

In some examples, the CoAP sender 210 may initiate a third message timer on sending the Release message. Upon expiry of the third message timer, if the CoAP sender 210 has not received a fourth message referred to as a “Complete” message and described in more detail below, from the CoAP receiver 220, the CoAP sender 210 may resend the Release message to the CoAP receiver 220. The third message timer may be configured substantially in the manner described in RFC 7252 for the message timer corresponding to sending of a Confirmable time message.

In step 224, the CoAP receiver 220 receives the Release message. Responsive to receiving the Release message, the CoAP receiver updates its record of the Guarantee message to indicate that the Received message, confirming receipt by the CoAP receiver 220 of the Guarantee message, has been received by the CoAP sender 210. In the illustrated example, updating comprises deleting the record of the Guarantee message (in this case at least a part of the first message identifier from the Guarantee message) from its memory. In step 226, the CoAP receiver 220 sends a fourth message to the CoAP sender, which may be another new message termed a “Complete” message, as illustrated in FIG. 2. As for the Received message, the Complete message may be implemented as a new message type “Complete” or via a new Option included in an Acknowledgement message. The Complete message confirms that CoAP receiver 220 has received the Release message.

In step 217, the CoAP sender 210 receives the Complete message from the CoAP receiver 220. Responsive to receiving the Complete message, the CoAP sender updates its record of the Received message. In the illustrated example of FIG. 2 this comprises step 218, in which the CoAP sender 210 deletes its copy of the Received message.

The message flow diagram 200 therefore illustrates an example exchange between a CoAP sender 210 and CoAP receiver 220, which can reliably confirm that a duplicate first message will be identified, and consequently that a Request carried in the Guarantee message is not processed multiple times by the CoAP receiver.

For example, referring still to FIG. 2, if the Received message sent by the CoAP receiver in step 223 is lost and does not reach the CoAP sender 210, the CoAP sender 210 may resend the first Guarantee message to the CoAP receiver 220. As the CoAP receiver 220 has stored a record of the Guarantee message, if the CoAP receiver receives another Guarantee message with a message identifier corresponding to the stored record in the CoAP receiver 220, the CoAP receiver 220 can identify the resent Guarantee message as a duplicate and process it accordingly. For example, the CoAP receiver may piggyback requested information onto a new Received message, but may ensure that any action requested by the duplicate message is not carried out, as such action will have already been carried out in response to receipt of the original Guarantee message. The CoAP receiver 220 will send a new Received message to confirm receipt of the resent Guarantee message.

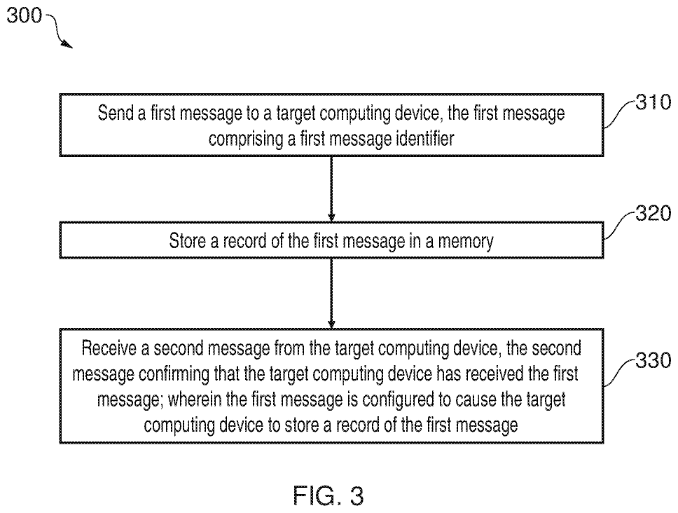

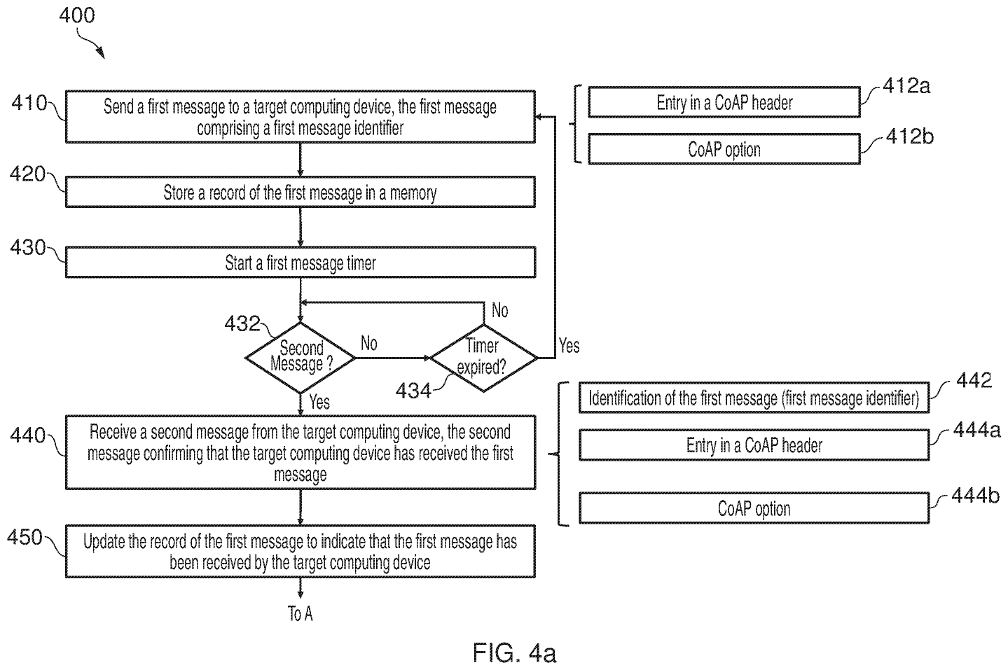

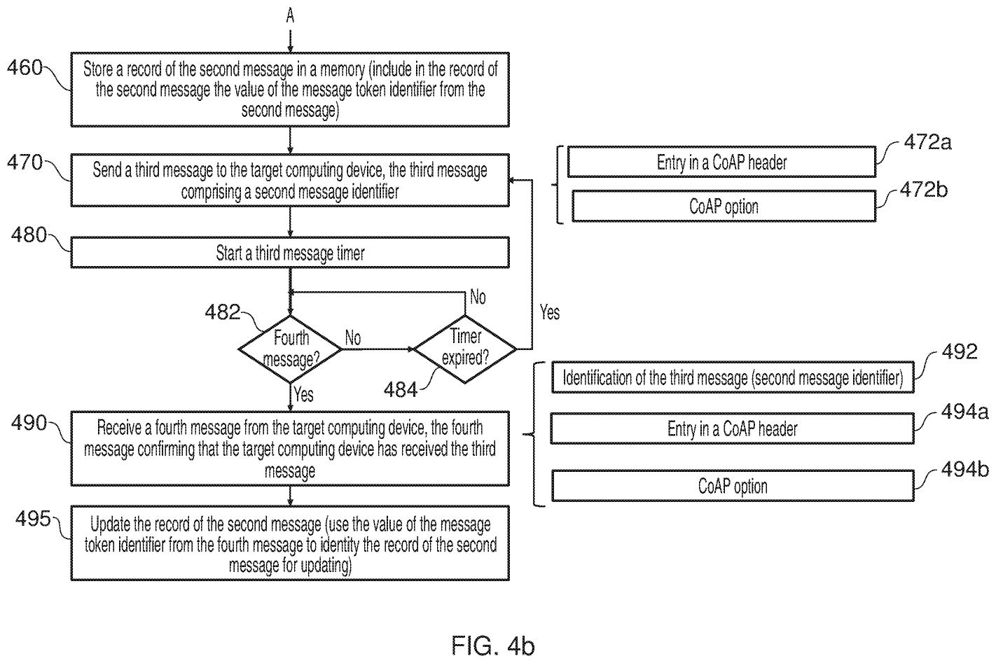

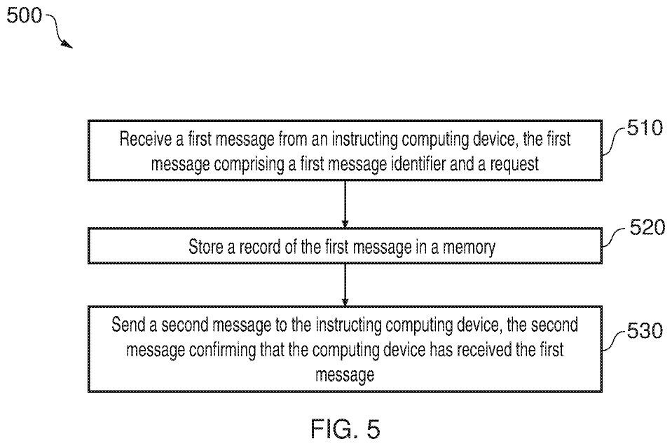

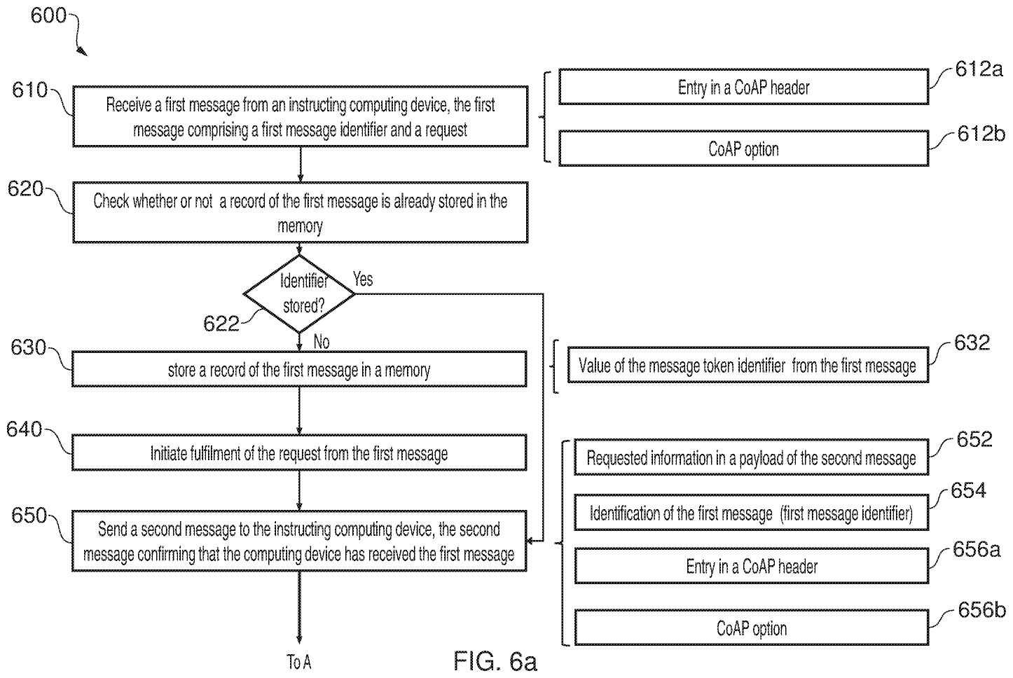

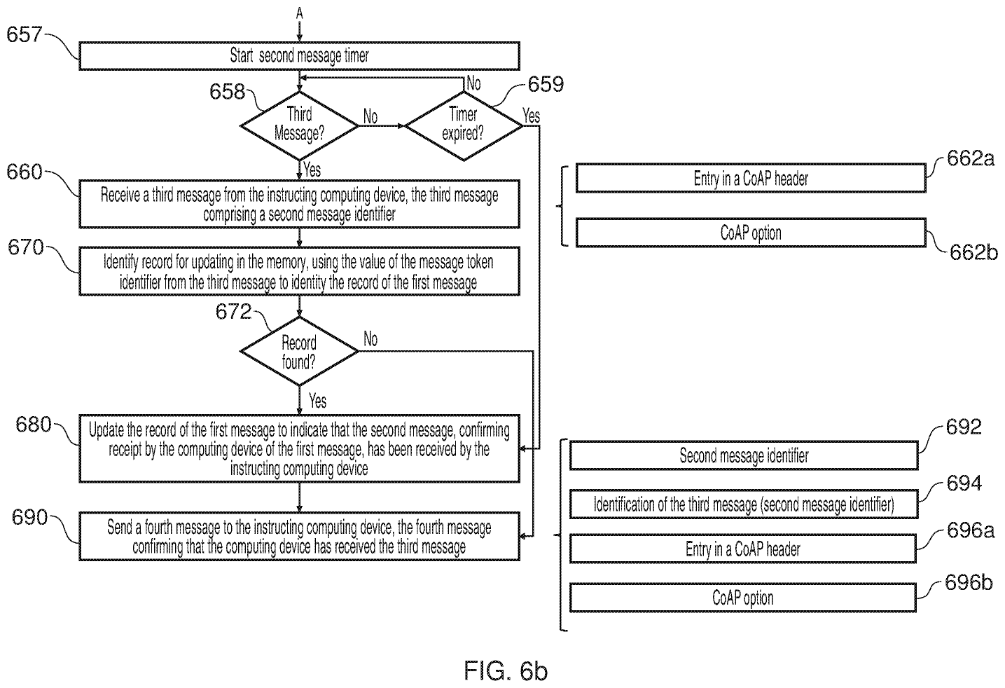

The message exchange of FIG. 2 is an example of how the new mechanism proposed according to examples of the present disclosure may operate. The mechanism may be carried out through the performance of methods at an instructing computing device, or CoAP sender (FIGS. 3, 4a and 4b), and a target computing device, or CoAP receiver (FIGS. 5, 6a and 6b). FIGS. 3 to 6b are flow charts illustrating process steps in such methods.

FIG. 3 is a flow chart illustrating process steps in an example of a method 300 performed by an instructing computing device operable to implement CoAP according to examples of the present disclosure. The instructing computing device may be a CoAP server or CoAP client and may by referred to as a CoAP sender.

Referring to FIG. 3, in step 310, the instructing computing device sends a first message to a target computing device, the first message comprising a first message identifier. The first message is configured to cause the target computing device to store a record of the first message.

The target computing device may also be operable to implement CoAP and may be referred to as a CoAP receiver. The messages exchanged between the instructing computing device and the target computing device may comprise CoAP messages.

In step 320, the instructing computing device stores a record of the first message in a memory. In step 330, the instructing computing device receives a second message from the target computing device, the second message confirming that the target computing device has received the first message.

As described above, configuring the first message such that the target computing device, on receipt of the first message, stores a record of the first message, enables the target computing device to recognise future duplicate messages and avoid unintended repeat processing of a message.

FIGS. 4a and 4b show a flow chart illustrating process steps in a further example of a method 400 performed by an instructing computing device operable to implement CoAP. The steps of the method 400 illustrate example ways in which the steps of the method 300 may be implemented and supplemented in order to achieve the above discussed and additional functionality.

Referring initially to FIG. 4a, in a first step 410, the instructing computing device sends a first message to a target computing device, the first message comprising a first message identifier. The first message may comprise a Guarantee message, as described above. The target computing device may also be operable to implement CoAP and may be referred to as a CoAP receiver. The first message may carry a Request and the target computing device may be configured to process the Request and send a Response to the instructing computing device, or to forward the Request for processing. The first message may alternatively comprise configuration information for the target computing device.

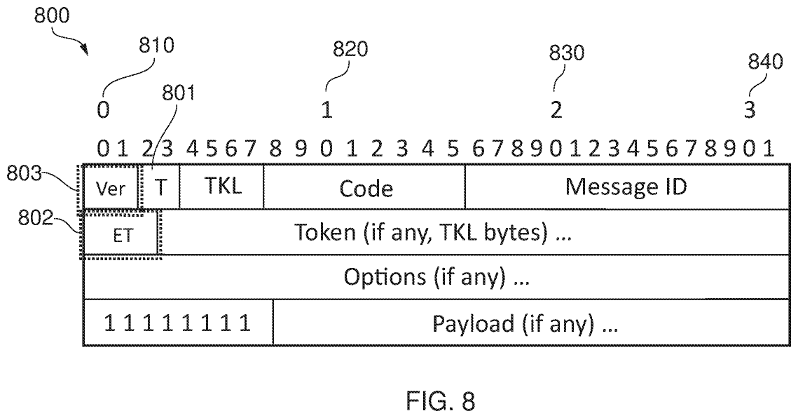

The first message is configured to cause the target computing device to store a record of the first message. As illustrated in step 412a this configuration may comprise the inclusion, in the first message, of an entry in a CoAP header of the first message. The entry may for example be an entry in the message type field of the CoAP header, which entry identifies the first message as a Guarantee type message. As illustrated in step 412b, the configuration may alternatively or in addition comprise inclusion in the first message of a CoAP Option, which Option may identify the first message as a Guarantee message. As will be described in more detail in relation to FIGS. 8-11, the entry in the CoAP header and/or the CoAP option is interpreted by the target computing device as requiring the target computing device to store a record of the first message.

In step 420, the instructing computing device stores a record of the first message in a memory. In some examples the record may comprise a copy of the first message. In some examples the record may comprise an identifier corresponding to the first message such as the first message identifier from the header of the first message.

In step 430, the instructing computing device starts a first message timer. The first message timer may use the CoAP confirmable message timer function, defined in the CoAP standard. In step 432, if the instructing computing device has not received a second message confirming that the target computing device has received the first message, the method proceeds to step 434 where the instructing computing device determines if the timer has expired. If the instructing computing device has not received a second message confirming that the target computing device has received the first message before expiry of the first message timer, the instructing computing device resends the first message to the target computing device, for example by returning to step 410.

In step 440, the instructing computing device receives a second message from the target computing device, the second message confirming that the target computing device has received the first message. The second message may comprise a Received message as described above. As illustrated in step 442, the second message may comprise an identification of the first message, such as the first message identifier from the first message. The second message may thus include the same message identifier as the first message. The message identifier in the second message may therefore be used by the instructing computing device to match the second message to the first message.

As illustrated in step 444a the second message may comprise an entry in a CoAP header of the second message which is interpreted by the instructing computing device as indicating that the first message has been received by the target computing device. The entry may for example be an entry in the message type field of the CoAP header, which entry identifies the second message as a Received type message. As illustrated in step 444b, the second message may comprise a CoAP Option which is interpreted by the instructing computing device as indicating that the first message has been received by the target computing device. The Option may identify the second message as a Received message. As will be described in more detail in relation to FIGS. 8-11, the entry in a CoAP header and/or the CoAP option may be interpreted by the instructing computing device as indicating that the first message has been received by the target computing device.

In step 450, responsive to the instructing computing device receiving the second message from the target computing device, the instructing computing device updates the record of the first message to indicate that the first message has been received by the target computing device. In some examples, the instructing computing device updating the record of the first message may comprise at least one of: deleting the record of the first message, tagging the record of the first message to indicate that the first message has been received by the target computing device, and/or moving the record of the first message to a storage associated with messages that have been received by a target computing device.

In step 460, responsive to the instructing computing device receiving the second message from the target computing device, the instructing computing device stores a record of the second message in a memory. The memory may comprise the same memory used to store a record of the first message and/or a separate memory. The record of the second message may comprise at least one of: a copy of the second message, at least part of the message identifier of the second message or any other suitable identifier corresponding to the second message or means of identifying the second message.

In some examples, the record of the second message may comprise a token identifier value, as described in RFC 7252, of the message token from the second message. Each of the first, second, third and fourth messages exchanged between the instructing computing device and target computing device may comprise the same token value. Therefore, as will be described in more detail below, the token value of the second message may be used to confirm that a third message sent from the instructing computing device to the target computing device was received by the target computing device.

In step 470, the instructing computing device sends a third message to the target computing device, the third message comprising a second message identifier. The third message may comprise a Release message as described above, and is configured to cause the target computing device to update its record of the first message to indicate that the second message, confirming receipt by the target computing device of the first message, has been received by the instructing computing device. The second message identifier may be different from the first message identifier.

As illustrated in 472a, the configuration of the third message may comprise the inclusion, in the third message, of an entry in a CoAP header of the third message which is interpreted by the target computing device as requiring the target computing device to update its record of the first message to indicate that the second message, confirming receipt by the target computing device of the first message, has been received by the instructing computing device. The entry may for example be an entry in the message type field of the CoAP header, which entry identifies the third message as a Release type message. As illustrated in step 472b, the configuration may alternatively or in addition comprise inclusion in the third message of a CoAP Option, which Option may identify the third message as a Release message. As will be described in more detail in relation to FIGS. 8-11, either or both of the CoAP header and/or CoAP option is interpreted by the target computing device as requiring the target computing device to update its record of the first message to indicate that the second message, confirming receipt by the target computing device of the first message, has been received by the instructing computing device.

In step 480, responsive to sending the third message, the instructing computing device is configured to start a third message timer. In step 482 the instructing computing device determines whether or not a fourth message has been received. If a fourth message has not been received, the instructing computing device determines whether or not the third message timer has expired in step 484. If the third message timer has expired, the instructing computing device resends the third message to the target computing device. The instructing computing device resends the third message in a similar manner to step 470.

In step 490, the instructing computing device receives a fourth message from the target computing device, the fourth message confirming that the target computing device has received the third message. The fourth message may comprise a Complete message as described above. As illustrated in step 492, the fourth message comprises an identification of the third message. The identification of the third message comprised in the fourth message may comprise at least a part of the message identifier of the third message (the second message identifier) and may also comprise the token value from the third message. The instructing computing device may use the second message identifier to match the fourth message to the third message, indicating that the third message has been received by the target computing device.

As illustrated in step 494a the fourth message may comprise an entry in a CoAP header of the fourth message which is interpreted by the instructing computing device as indicating that the third message has been received by the target computing device. The entry may for example be an entry in the message type field of the CoAP header, which entry identifies the fourth message as a Complete type message. As illustrated in step 494b, the fourth message may comprise a CoAP Option which is interpreted by the instructing computing device as indicating that the third message has been received by the target computing device. The Option may identify the fourth message as a Complete message. As will be described in more detail in relation to FIGS. 8-11, the fourth message may comprise either or both of the entry in a CoAP header and the CoAP option which may be interpreted by the instructing computing device as indicating that the third message has been received by the target computing device.

In step 495, the instructing computing device updates the record of the second message. The instructing computing device may use the value of the message token identifier, as described in RFC 7252, from the fourth message to identity the record of the second message for updating. Updating the record of the second message may comprise at least one of: deleting the record of the second message, tagging the record of the second message to indicate that the first message has been received by the target computing device, and/or moving the record of the second message to a storage associated with received messages. Updating the record of the second message in this manner may signify that the message exchange between the instructing computing device and the target computing device is complete, with the first message having been received by the target computing device.

The methods 300 and 400, performed by an instructing commuting device, or CoAP sender, may be complimented by methods performed by a target computing device, or CoAP receiver, as illustrated in FIGS. 5, 6a and 6b.

FIG. 5 is a flow chart illustrating process steps in an example of a method 500 performed by a target computing device operable to implement CoAP according to examples of the present disclosure. The target computing device may be a CoAP server or CoAP client and may be referred to as a CoAP receiver.

Referring to FIG. 5, in a first step 510, the target computing device receives a first message from an instructing computing device, the first message comprising a first message identifier and a Request. The instructing computing device may be referred to as a CoAP sender, and may be a CoAP server or a CoAP client.

In step 520, responsive to receiving the first message, the target computing device stores a record of the first message in a memory. In step 530, responsive to receiving the first message, the target computing device sends a second message to the instructing computing device, the second message confirming that the target computing device has received the first message.

FIGS. 6a and 6b show a flow chart illustrating process steps in a further example of a method 600 performed by a target computing device operable to implement CoAP. The steps of the method 600 illustrate example ways in which the steps of the method 500 may be implemented and supplemented in order to achieve the above discussed and additional functionality. As for the method 500, the target computing device may be a CoAP server or CoAP client and may be referred to as a CoAP receiver.

Referring initially to FIG. 6a, in a first step 610, the target computing device receives a first message from an instructing computing device, the first message comprising a first message identifier and a Request. In some examples, the first message identifier may comprise a CoAP message identifier of the first message. In some examples, the Request may comprise a request for information, such as a sensor reading, or an instruction to perform an action e.g. to carry out a payment or transaction.

As illustrated in step 612a the first message may comprise an entry in a CoAP header of the first message which is interpreted by the target computing device as requiring the target computing device to store a record of the first message. The entry may for example be an entry in the message type field of the CoAP header, which entry identifies the first message as a Guarantee type message. As illustrated in step 612b, the first message may alternatively or in addition comprise inclusion in the first message of a CoAP Option which is interpreted by the target computing device as requiring the target computing device to store a record of the first message. The Option may identify the first message as a Guarantee message. As will be described in more detail in relation to FIGS. 8-11, either or both of the CoAP header and the CoAP option may be interpreted by the target computing device as requiring the target computing device to store a record of the first message.

In step 620, responsive to receiving the first message, the target computing device checks whether or not a record of the first message is already stored in the memory. In some examples the target computing device may check if the first message identifier corresponds with or matches with a record stored in the memory of the target computing device.

In step 622, the target computing device determines whether or not a record of the first message is already stored in the memory. In response to the target computing device determining that a record of the first message is not already stored in the memory, in step 630 the target computing device stores a record of the first message in a memory. The record of the first message may comprise at least one of: a copy of the first message, at least part of the first message identifier or any other suitable identifier corresponding to the first message. In step 632, the target computing device may include with the record of the first message that is stored in the memory the value of the message token identifier from the first message. As described above, the first, second, third and fourth messages all include a token identifier having the same value. Therefore, as will be described in more detail below, the token value of the first message may be used to match a third message, received form the instructing computing device and confirming that a second message sent by the target computing device was received by the instructing computing device, to the record of the first message.

In step 640, the target computing device initiates fulfilment of the Request from the first message. In some examples, initiating fulfilment of the request may comprise at least one of: forwarding the request for further processing, processing the payload of the request, and/or performing an action according to the request e.g. obtaining a temperature reading, adding a charge to an account etc.

In step 650, the target computing device sends a second message to the instructing computing device, the second message confirming that the target computing device has received the first message. As illustrated in step 652, if the Request carried in the first message comprises a request for information, the second message may include the requested information in a payload of the second message. As illustrated in step 654, the second message may comprise an identification of the first message, which identification may comprise at least a part of the first message identifier. In some examples, the identification of the first message may comprise the token value from the first message.

As illustrated in step 456a the second message may comprise an entry in a CoAP header of the second message, which is interpreted by the instructing computing device as indicating that the first message has been received by the target computing device. The entry may for example be an entry in the message type field of the CoAP header, which entry identifies the second message as a Received type message. As illustrated in step 444b, the second message may comprise a CoAP Option which is interpreted by the instructing computing device as indicating that the first message has been received by the target computing device. The Option may identify the second message as a Received message. As will be described in more detail with reference to FIGS. 8-11, either or both of the CoAP header and the CoAP option may be interpreted by the instructing computing device as indicating that the first message has been received by the target computing device.

Referring again to step 622, in response to the target computing device determining that a record of the first message is already stored in the memory, the target computing device does not carry out steps 630 and 630, and proceeds directly to step 650. If a record of the first message is already stored in the memory, this indicates that the newly received first message is in fact a duplicate, and that the target computing device has therefore already carried out step 630 and 640, storing the record and initiating fulfilment of the Request from the first message. The target computing device therefore omits these steps on determining that the newly received first message is a duplicate, and proceeds directly to sending the second message in step 650. The second message confirms receipt of the first message and, if the Request carried in the first message included a request for information from the target computing device, the second message may include the requested information, as it may be assumed that the second message sent in response to the original first message has not been received by the instructing computing device.

Referring now to FIG. 6b, in step 657 responsive to sending the second message, the target computing device starts a second message timer. In step 658, the target computing device determines whether or not a third message has been received. If a third message has not been received, the target computing device determines whether or not the second message timer has expired in step 659. If the second message timer has expired, the target computing device updates the record of the first message in step 680, as will be described in more detail below.

In step 660, the target computing device receives a third message from the instructing computing device, the third message comprising a second message identifier, which may be different to the first message identifier. The third message may be configured to cause the target computing device to update its record of the first message to indicate that the second message, confirming receipt by the target computing device of the first message, has been received by the instructing computing device.

As illustrated in 662a, the third message may comprise an entry in a CoAP header of the third message which is interpreted by the target computing device as requiring the target computing device to update its record of the first message to indicate that the second message, confirming receipt by the target computing device of the first message, has been received by the instructing computing device. The entry may for example be an entry in the message type field of the CoAP header, which entry identifies the third message as a Release type message. As illustrated in step 662b, the third message may alternatively or in addition comprise a CoAP Option, which Option may identify the third message as a Release message. As will be described in more detail with reference to FIGS. 8-11, either or both of the CoAP header and the CoAP option may be interpreted by the target computing device as requiring the target computing device to update its record of the first message to indicate that the second message, confirming receipt by the target computing device of the first message, has been received by the instructing computing device.

In step 670, the target computing device identifies a record of the first message for updating. The target computing device may use a value of the message token from the third message to identity the record of the first message for updating. As described above, the first, second, third and fourth messages all contain the same token identifier value, and the token value for the third message can therefore be used by the target computing device to identify the correct record of the first message for updating.

In step 672, the target computing device determines if the record of the first message has been found. In step 680, if the record of the first message has been found in the memory, the target computing device updates the record of the first message to indicate that the second message, confirming receipt by the target computing device of the first message, has been received by the instructing computing device. Updating the record of the first message may comprise at least one of: deleting the record of the first message, tagging the record of the first message to indicate that the second message has been received by the instructing computing device, and/or moving the record of the first message to a storage associated with received messages.

In step 690, the target computing device sends a fourth message to the instructing computing device, the fourth message confirming that the target computing device has received the third message. As illustrated in step 694, the fourth message comprises an identification of the third message. In some examples, the identification of the third message may comprise the second message identifier, included in the third message. The second message identifier may therefore be used by the instructing computing device to match the fourth message to the third message.

As illustrated in step 696a the fourth message may comprise an entry in a CoAP header of the fourth message which is interpreted by the instructing computing device as indicating that the third message has been received by the target computing device. The entry may for example be an entry in the message type field of the CoAP header, which entry identifies the fourth message as a Complete type message. As illustrated in step 696b, the fourth message may comprise a CoAP Option which is interpreted by the instructing computing device as indicating that the third message has been received by the target computing device. The Option may identify the fourth message as a Complete message. As will be described in more detail with reference to FIGS. 8-11, either or both of the CoAP header and the CoAP option may be interpreted by the instructing computing device as indicating that the third message has been received by the target computing device.

FIGS. 3 to 6b thus illustrate how methods carried out at an instructing computing device and a target computing device may implement examples of the new mechanism proposed in the present disclosure.

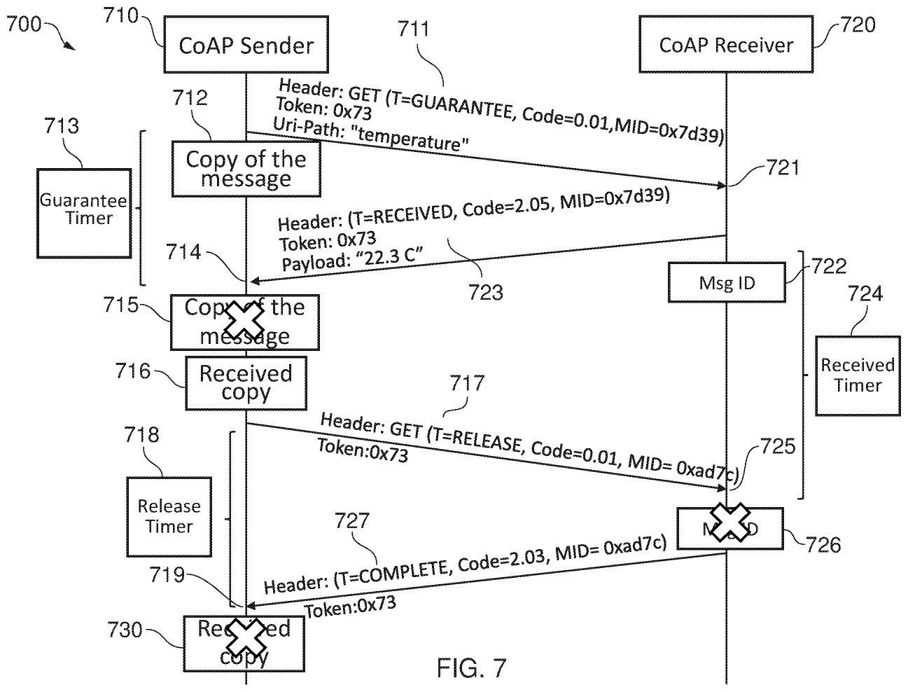

FIG. 7 is a message flow diagram 700 illustrating an example message exchange between two computing devices operable to implement CoAP and carrying out examples of the methods described above.

FIG. 7 illustrates the exchange between an instructing computing device or CoAP sender 710 and a target computing device or CoAP receiver 720. The exchange between the CoAP sender 710 and the CoAP receiver 720 illustrated in FIG. 7 substantially corresponds to the exchange 200 described above with reference to FIG. 2. FIG. 7 illustrates further detail of the information carried in the messages between the CoAP sender 710 and the CoAP receiver 720.

Referring to FIG. 7, in step 711, the CoAP sender 710 sends a Guarantee message to the CoAP receiver 720. As illustrated, the header of the guarantee message specifies the type (T) as “T=GUARANTEE”. This indicates to the CoAP receiver 720 that the message is a Guarantee message and the CoAP receiver 720 will process the Guarantee message, as described above in relation to FIGS. 2, 3, 4a and 4b.

Referring again to step 711, the header of the Guarantee message further comprises a message identifier (MID)=0x7d39. The Guarantee message further comprises a token value: 0x73. As described above, the Guarantee message may comprise a Request. In step 711, the request may comprise a request for a temperature reading in the form of the Uri-Path: “temperature”. The CoAP sender saves a copy of the Guarantee message in step 712 and in step 713 starts a Guarantee message timer.

The CoAP receiver receives the Guarantee message in step 721. In step 722 the CoAP receiver 720 stores a record of the Guarantee message in its memory and, in step 723, sends a Received message to the CoAP sender 710 to confirm recipient of the Guarantee message. The header of the Received message specifies the message type T as “T=RECEIVED”. The message identifier of the Received message “MID=0x7d39” is the same as the message identifier of the Guarantee message. The token value of the Received message matches the token value of the Guarantee message.

In step 724, the CoAP receiver 720 initiates a Received message timer, in response to sending the Received message. As described above, upon expiry of the Received message timer, if the CoAP receiver has not received a Release message from the CoAP sender 710, the CoAP receiver 720 updates the record of the Guarantee message.

If the Guarantee message includes a request for information, the CoAP receiver 720 may include the requested information in the payload of the Received message. Therefore, in step 723, the payload of the received message comprises the requested temperature reading “22.3 C”. The CoAP sender 710 receives the Received message in step 714, matches the received message to the sent Guarantee message using the message identifier 0x7d39 and updates its record of the Guarantee message by deleting it in step 715. The CoAP sender 710 stores a copy of the Received message in its memory in step 716, and it also stops the Guarantee message timer, as a received message has been received before expiry of the timer.

In step 717, the CoAP sender sends a Release message to the CoAP receiver. The header of the release message specifies the message type as “T=RELEASE”. The message identifier of the Release message is different to that of the Guarantee and Received messages but it comprises the same token value “0x73” as the Guarantee and Received messages.

In step 718, the CoAP sender initiates a Release message timer, in response to sending the Release message. As described above, if the CoAP sender 710 has not received a Complete message upon expiry of the Release message timer, the CoAP sender may resend the Release message.

In step 725, the CoAP receiver 720 receives the Release message, and uses the message token value from the Release message to find the correct record of the Guarantee message for updating. The CoAP receiver 720 then updates the record of the Guarantee message by deleting it in step 726. In response to receiving the Release message, the CoAP receiver 720 may also stop the Received message timer, as a Received message has been received before expiry of the timer.

In step 727, a Complete message is sent from the CoAP receiver 720 to the CoAP sender 710 to confirm recipient of the Release message by the CoAP receiver. The Complete message includes the message type “T=COMPLETE”. The complete message includes the same message identifier as the Release message: “MID=0xad7c”. The Complete message comprises the same token value as the Guarantee message, Received message and the Release message: “Token: 0x73”. The CoAP sender receives the Complete message in step 719 and uses the message token value from the Complete message to identify the record of the corresponding Received message. This record is deleted in step 730, completing the mechanism for ensuring that the Guarantee message is received and acted upon only once.

As described above, examples of a new CoAP message exchange mechanism according to the present disclosure may comprise four new CoAP messages, which may be termed: Guarantee, Received, Release and Complete. In some examples the new messages may be implemented as new message types. The message type field in the CoAP header may in such examples be extended, or a new Extended Type field may be added, such that the new message types may be signalled in the header of each message.

FIG. 8 illustrates an example of a CoAP message 800. The CoAP standard defines a 2-bit field in the CoAP header to represent the CoAP message types. However, the 4 values that may be represented in this 2-bit field are already used to identify the four messages presently defined in the CoAP standard (confirmable, non-confirmable, acknowledge and reset). The two-bit field is represented by “T” 801.

Examples according to the present disclosure therefore propose to extend the CoAP header.

In a first example, the CoAP header may be extended to a 3-bit field. The extended 3-bit field may take the position of the extended type field “ET” 802. In one example, the extended type field “ET” 802 may be set a value, which will be indicative of the new message type. In one example, the new message types may be represented as 1=Guarantee, 2=Received, 3=Release and 4=Complete. When a computing device, which may be an instructing or a target computing device operable to implement CoAP, receives a message, where the ET field 802 contains one of these values, the computing device will recognise the message as one of the new message types. In one example, the ET field 802 may also be set to a value of 0. With the ET field 802 set to 0, a computing device operable to implement CoAP will consult the T field 801 to determine the message type, which will contain a value corresponding to one of the four previously specified CoAP messages (confirmable, non-confirmable, acknowledge and reset).

In addition to including the ET filed 802, the CoAP version type “Ver” field 803 of the header may also be modified. The CoAP standard defines that the Ver field 803 is set to 1 (01 binary). In one example, with the ET filed 802 included in the CoAP header, the Ver field 803 may be set to 2 (10 binary).

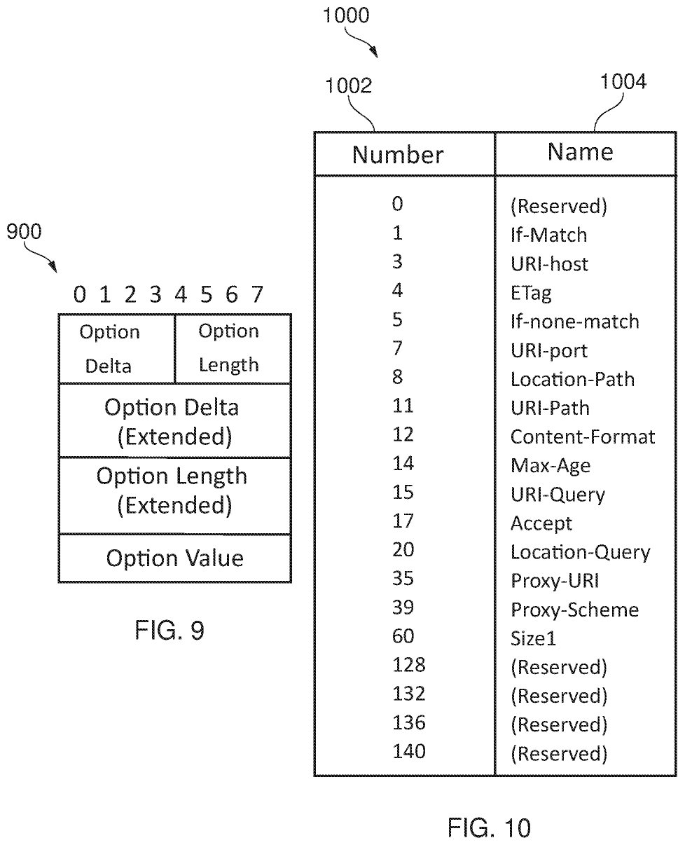

In another example for extending the CoAP header, the CoAP header may comprise a series of new CoAP Options. The CoAP standard defines a number of Options that may be included in a given message. Each Option in a message specifies the Option number of the defined CoAP Option, the length of the Option Value, and the Option Value itself. FIG. 9 illustrates the CoAP option format 900, which is defined in the CoAP standard (RFC 7252).

CoAP defines a set of Options that are used in both Request messages and Response messages. FIG. 10 illustrates the current CoAP Options listed in the CoAP standard (RFC 7252). The CoAP standard defines the semantics of these options along with their properties. An Option is identified by an Option number, which also provides some additional semantics information, for example, odd numbers indicate a critical option, while even numbers indicate an elective option.

The CoAP standard allows the possibility to define new Options. According to examples of the present disclosure, a new option, for example “extended type” could be defined in CoAP to represent the four proposed new messages according to the present disclosure (Guarantee, Received, Release and Complete).

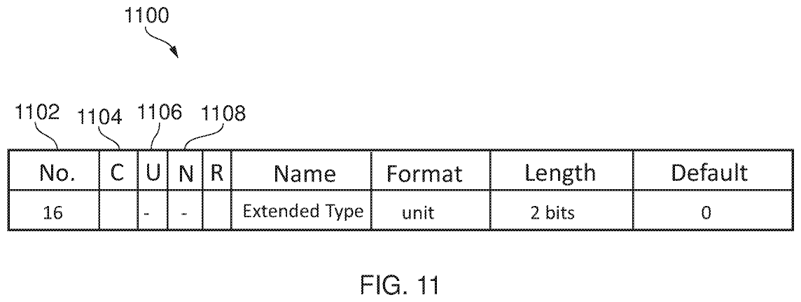

FIG. 11 illustrates an example of a new 2-bit option that may be defined in CoAP to express the four proposed new message types. In some examples, the option number 1102 may comprise any unused even number. In the illustrated example of FIG. 11, the option number comprises 16. The C 1104, U 1106 and N 1108 columns indicate the properties Critical, UnSafe and NoCacheKey, respectively. In some examples, the new 2-bit option may be elective. An elective option is silently ignored by a CoAP receiver if the option is unrecognized. The critical column C 1104 may therefore define that the option is elective.

The Unsafe column, U 1106 defines how a proxy deals with the option if the proxy does not recognize the option. The UnSafe column, U 1106, may therefore indicate that the option is Unsafe to forward by setting the UnSafe column U to a value. The UnSafe column, U 1106, may indicate that an option is safe to forward by setting the UnSafe column as clear comprising no value.

The NoCacheKey column, N 1108, is relevant for proxies. When set, the proxies maintain a copy of the NoCacheKey field. The definition of some options specifies that those options are repeatable. An option that is repeatable may be included one or more times in a message. In some examples, the new 2-bit option may not be repeatable.

The extension of the CoAP header described above may therefore provide four new CoAP message types. The new message types may thus be provided either as a new entry in a CoAP header or as a new CoAP Option. In some examples, the new message types may be provided as both a new entry in a CoAP header and a new CoAP option. A computing device operable to implement CoAP may thus generate one of the new message types by setting an entry in a CoAP header and/or setting the CoAP option accordingly.

For example, a CoAP sender may generate a Guarantee message by setting the CoAP header and/or the CoAP option of the guarantee message accordingly. The CoAP sender may then send this message to a CoAP receiver. Upon receiving the Guarantee message, the CoAP receiver may read the CoAP header and/or the CoAP option of the Guarantee message and interpret the header entry or Option as requiring the receiver to store a record of the Guarantee message and confirm receipt of the Guarantee message to the CoAP sender, as described above.

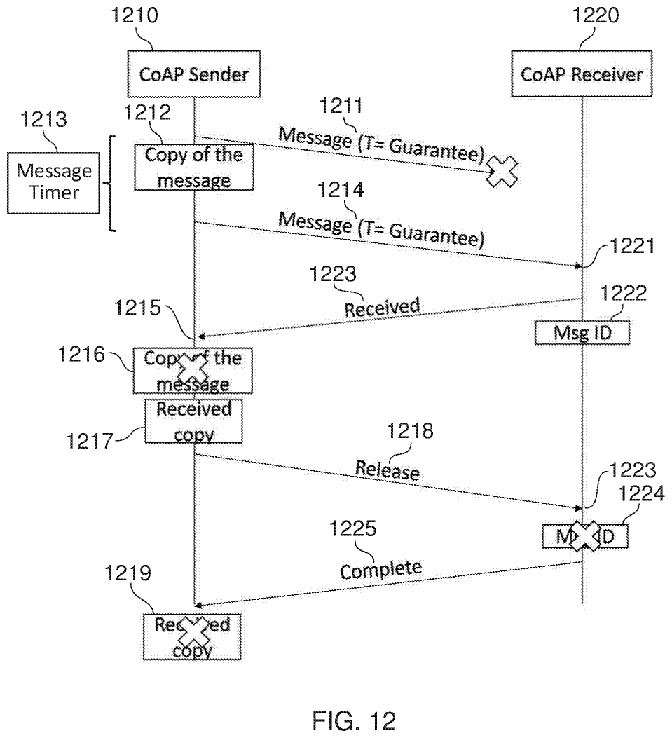

FIGS. 12, 13, 14 and 15 are message flow diagrams illustrating example exchanges between a CoAP sender and CoAP receiver according to different examples of the methods discussed above. The message exchanges of FIGS. 12 to 15 illustrate how example methods according to the present disclosure handle situations in which one of the first, second, third or fourth messages is lost, and so not delivered to its intended recipient.

In the example message exchange of FIG. 12 between a CoAP sender 1210 and a CoAP receiver 1220, in step 1211 the CoAP sender sends a Guarantee message to the CoAP receiver 1220. However, in the exchange of FIG. 12, the Guarantee message sent in step 1211 is lost and does not reach the CoAP receiver 1220.

In response to sending the guarantee message, in step 1212 the CoAP sender 1210 stores a copy of the Guarantee message and initiates a Guarantee message timer. Upon expiry of the Guarantee message timer, if the CoAP sender has not received a Received message, confirming recipient of the Guarantee message, from the CoAP receiver 1220, in step 1214 the CoAP sender 1210 resends the Guarantee message. The CoAP sender 1210 not receiving the Received message before expiry of the Guarantee message timer may be indicative that either the Guarantee message or the corresponding Received message has been lost between the CoAP sender 1210 and the CoAP receiver 1220 and therefore the Guarantee message should be resent.

In step 1221, the CoAP receiver receives the resent Guarantee message. The message exchange then precedes with steps 1215 to 1219 and 1222 to 1225 substantially as described above with reference to FIG. 2.

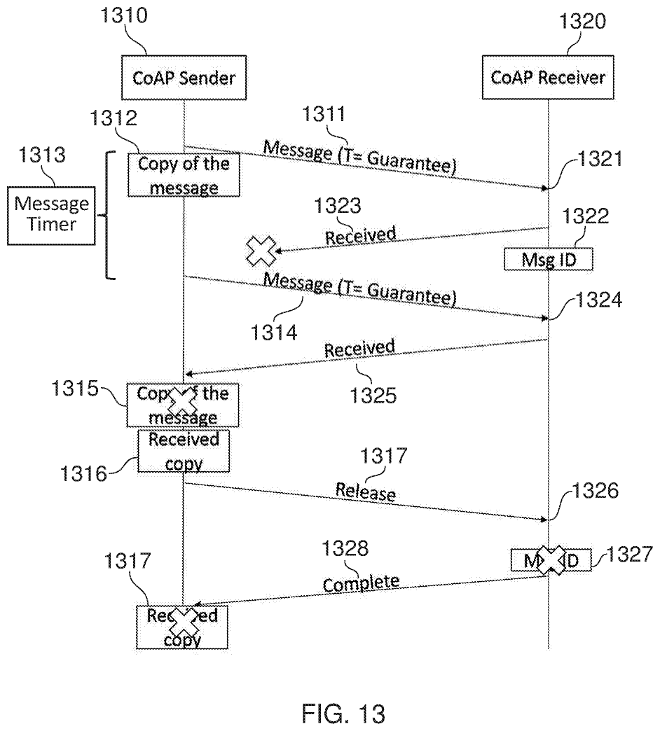

In the example message exchange of FIG. 13 between a CoAP sender 1310 and a CoAP receiver 1320, in step 1311 the CoAP sender 1310 sends a Guarantee message to the CoAP receiver 1320. In response to sending the Guarantee message, in step 1312 the CoAP sender 1310 stores a copy of the guarantee message and initiates a Guarantee message timer.

In step 1321, the CoAP receiver 1320 receives the Guarantee message from the CoAP sender 1310. In response to receiving the Guarantee message, in step 1322 the CoAP receiver 1320 stores a record, in this case a message identifier, of the Guarantee message and initiates fulfilment of a Request included in the message. In step 1323 the CoAP receiver 1320 sends a Received message confirming receipt of the Guarantee message to the CoAP sender 1310. In the message exchange of FIG. 13, the Received message is lost between the CoAP sender 1310 and the CoAP receiver 1320 and is not received by the CoAP sender 1310.

The Guarantee message timer initiated by the CoAP sender 1310 in step 1313 therefore expires without the CoAP sender 1310 receiving a Received message. In response to the timer expiring, in step 1314 the CoAP sender 1310 resends the Guarantee message.

In step 1324, the CoAP receiver 1320 receives the resent Guarantee message. The CoAP receiver 1320 check whether the message identifier of the resent Guarantee message matches the message identifier stored by the CoAP receiver in step 1322. If the stored message identifier matches the message identifier of the resent Guarantee message, the CoAP receiver may assume that the resent Guarantee message is a duplicate, and therefore resend an appropriate Received message without initiating fulfilment of the Request contained in the duplicate Guarantee message.

In step 1325, the CoAP receiver 1320 resends a Received message to the CoAP sender 1310, to confirm recipient of the resent Guarantee message. The CoAP receiver may include in the resent Received message any information requested by the CoAP sender in the resent Guarantee message. The CoAP sender 1310 receives the resent Received message. The message exchange then continues with steps 1315 to 1317 and 1326 and 1327, substantially as described above in relation to FIG. 2.

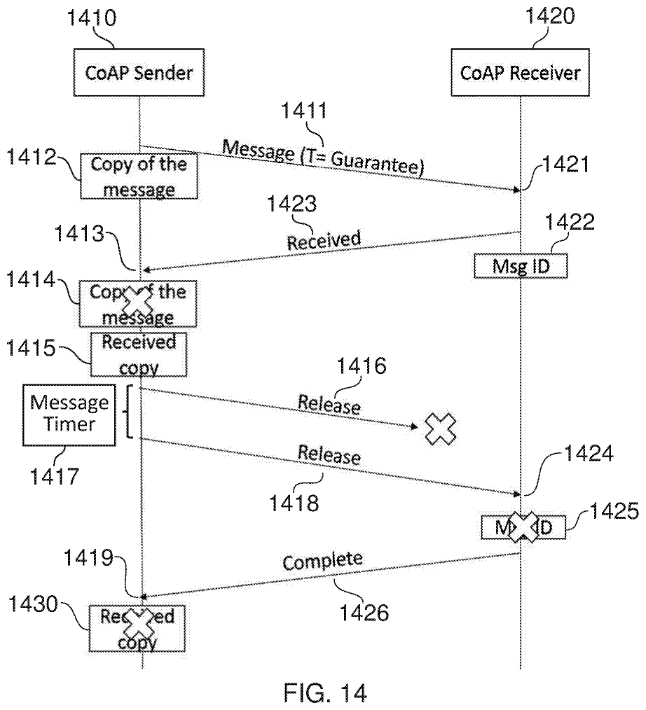

In the example message exchange of FIG. 14 between a CoAP sender 1410 and a CoAP receiver 1420, in step 1411 the CoAP sender 1410 sends a Guarantee message to the CoAP receiver 1420. The CoAP sender 1410 performs the steps 1412-1415, and the CoAP receiver 1420 performs the steps 1421-1423, which substantially correspond to the steps 212-215 and 221-223, respectively, described above in relation to FIG. 2.

In step 1416, the CoAP sender 1410 sends a Release message to the CoAP receiver 1420 and, in step 1417, the CoAP sender initiates a Release message timer. In the illustrated exchange, the Release message is lost between the CoAP sender 1410 and the CoAP receiver 1420 and does not reach the CoAP receiver 1420. The Release message timer therefore expires without the CoAP sender 1410 receiving a Complete message, confirming that the release message has been received by the CoAP receiver 1420. Responsive to the timer expiring, in step 1418 the CoAP sender resends the Release message.

In step 1424 the CoAP receiver 120 receives the Release message. The message exchange then continues with steps 1419-1430 and 1425-1426, which substantially correspond to the steps 217-218 and 225-226, respectively, described above in relation to FIG. 2.

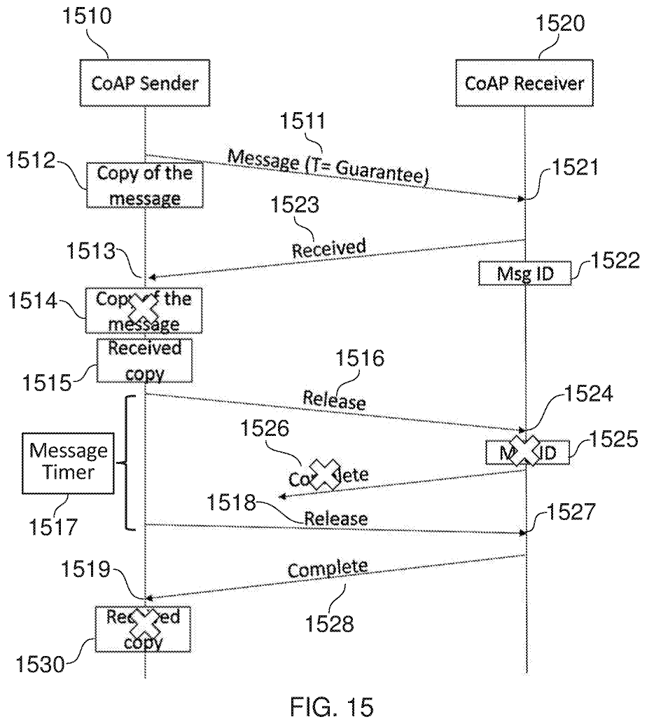

In the example message exchange of FIG. 15 between a CoAP sender 1510 and a CoAP receiver 1520, in step 1511 the CoAP sender 1510 sends a Guarantee message to the CoAP receiver 1520. The CoAP sender 1510 performs the steps 1512-1516 and the CoAP receiver 1520 performs the steps 1521-1525, which substantially correspond to the steps 212-216 and 221-225, respectively, described above in relation to FIG. 2.

In step 1526, the CoAP receiver 1520 sends a Complete message to the CoAP sender 1510 to confirm receipt of the Release message. In the illustrated example, the Complete message is lost between the CoAP receiver 1520 and the CoAP sender 1510 and does not reach the CoAP sender 1510.

In step 1517, responsive to sending the Release message, the CoAP sender may initiate a Release timer. If the CoAP sender 1510 has not received a Complete message, confirming that the Release message has been received by the CoAP receiver 1520 upon expiry of the timer, then in step 1518 the CoAP sender resends the Release message and restarts the Release timer.

In step 1527, the CoAP receiver 1520 receives the Release message. The CoAP sender processes the Release message and sends a new Complete message in step 1528. The record of the Guarantee message will already have been deleted by the CoAP receiver 1520 in response to receipt of the first Release message, and so the CoAP receiver 1520 simply resends a Complete message. On receipt of the Complete message in step 1519, the CoAP sender 1510 deletes its record of the Received message in step 1530.

The methods 300 to 600, as discussed above, may be performed by instructing and target computing devices, which devices may be operable to implement CoAP and may for example be running a CoAP client or a CoAP server.

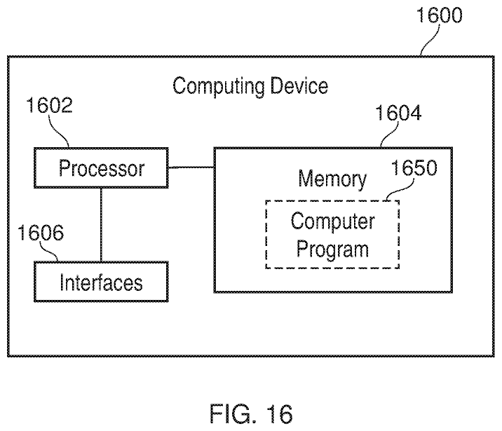

FIG. 16 is a block diagram illustrating an example computing device 1600 which is operable to implement CoAP and may comprise an instructing computing device or a target computing device. The computing device 1600 may implement the method 300 and/or 400 and/or 500 and/or 600 according to examples of the present disclosure, for example on receipt of suitable instructions from a computer program 1650. Referring to FIG. 16, the computing device 1600 comprises a processor or processing circuitry 1602, and may comprise a memory 1604 and interfaces 1606. The processing circuitry 1602 is operable to perform some or all of the steps of the method 300 and/or 400 and/or 500 and/or 600 as discussed above with reference to FIGS. 3, 4a, 4b, 5, 6a and 6b. The memory 1604 may contain instructions executable by the processing circuitry 1602 such that the computing device 1600 is operable to perform some or all of the steps of the method 300 and/or 400 and/or 500 and/or 600. The instructions may also include instructions for executing one or more telecommunications and/or data communications protocols. The instructions may be stored in the form of the computer program 1650. In some examples, the processor or processing circuitry 1602 may include one or more microprocessors or microcontrollers, as well as other digital hardware, which may include digital signal processors (DSPs), special-purpose digital logic, etc. The processor or processing circuitry 1602 may be implemented by any type of integrated circuit, such as an Application Specific Integrated Circuit (ASIC), Field Programmable Gate Array (FPGA) etc. The memory 1604 may include one or several types of memory suitable for the processor, such as read-only memory (ROM), random-access memory, cache memory, flash memory devices, optical storage devices, solid state disk, hard disk drive etc.

Examples of the present disclosure thus provide an instructing computing device and a target computing device operable to implement CoAP, and methods performed by instructing and target computing devices operable to implement CoAP, that expand on the existing CoAP protocol. The CoAP protocol as currently specified provides best effort delivery, which is unable to detect duplicate messages, and so to prevent duplicate processing of a request. In the currently specified protocol, if an Acknowledge message that is sent in response to a Confirmable message is lost between a CoAP sender and CoAP receiver, the Confirmable message is resent, and the CoAP receiver has no way of determining that the resent Confirmable message is a duplicate. This can lead to duplicate processing of a Request sent in a confirmable message, with unacceptable consequences in certain operational situations.

Examples of the present disclosure provide a message exchange mechanism between a CoAP sender and a CoAP receiver that avoid any such duplicate processing. The new mechanism proposes four new CoAP messages, which may be implemented as new message types or as Options to be included in existing message types, which Options will modify the behaviour of senders and receivers of such messages. In addition, the new mechanism proposes three timers implemented by the CoAP sender and CoAP receiver to ensure reliability of message delivery. According to examples of the new mechanism, both the CoAP sender and CoAP receiver may maintain a record of sent and/or received messages, enabling the sender and receiver to cooperate such that duplicate messages are detected.

Examples of the present disclosure may improve the security of message exchange between a CoAP sender and a CoAP receiver. For example, it may be envisaged that a malicious party may send multiple Guarantee messages to a CoAP receiver, causing the CoAP receiver to store a record of each of the Guarantee messages. The malicious party may purposely avoid sending any Release messages to the CoAP receiver, which would cause the CoAP receiver to update its record of the stored Guarantee messages, for example by deleting them or moving them to different storage. The aim of such behaviour may be to cause the memory capacity of the CoAP receiver to become overloaded, which may cause the CoAP receiver to crash. Examples of the present disclosure protect against such attacks using the second message timer, also referred to as the Received message timer. Upon expiry of the second message timer or Received message timer, initiated by the CoAP receiver in response to sending the Received message, if a corresponding Release message has not been received, the CoAP receiver updates its record of the Guarantee message, for example by deleting the record. The behaviour associated with the second message timer or release message timer therefore prevents the memory of the CoAP receiver becoming overloaded.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-38. (canceled)

39. An instructing computing device operable to implement a Constrained Application Protocol (CoAP), the instructing computing device comprising processing circuitry configured to:
send a first message to a target computing device, wherein the first message comprises a first message identifier and the first message is configured to cause the target computing device to store a record of the first message by including in the first message at least one of: a) an entry in a CoAP header or b) a CoAP option, which is interpreted by the target computing device as requiring the target computing device to store a record of the first message;
store in a memory a record of the first message;
receive a second message from the target computing device, the second message confirming that the target computing device has received the first message and comprising i) an identification of the first message and ii) at least one of: a) an entry in a CoAP header or a CoAP option, which is interpreted by the instructing computing device as indicating that the first message has been received by the target computing device; and
responsive to receiving the second message:
i) update the record of the first message to indicate that the first message has been received by the target computing device;
ii) send a third message to the target computing device, the third message comprising a second message identifier, wherein the third message is configured to cause the target computing device to update its record of the first message to indicate that the second message has been received by the instructing computing device; and
iii) receive a fourth message from the target computing device, the fourth message confirming that the target computing device has received the third message.

40. The instructing computing device of claim 39, wherein the processing circuitry is further configured to:
responsive to receiving the second message, store a record of the second message; and
responsive to receiving the fourth message confirming that the third message has been received by the target computing device, update the record of the second message.

41. The instructing computing device of claim 39, wherein each of the first, second, third, and fourth messages comprises a message token identifier having the same value.

42. The instructing computing device of claim 39, wherein the processing circuitry is further configured to, responsive to sending the first message:
start a first message timer; and
resend the first message to the target computing device as a result of the instructing computing device not receiving a second message confirming that the target computing device has received the first message before expiry of the first message timer.

43. The instructing computing device of claim 39, wherein the processing circuitry is further configured to, responsive to sending the third message:
start a third message timer; and
if the instructing computing device has not received a fourth message confirming that the target computing device has received the third message before expiry of the third message timer, resend the third message to the target computing device.

44. The instructing computing device of claim 39, wherein the third message is configured to cause the target computing device to update its record of the first message to indicate that the second message has been received by the instructing computing device, by including in the third message at least one of: an entry in a CoAP header or a CoAP option, which is interpreted by the target computing device as requiring the target computing device to update its record of the first message to indicate that the second message, confirming receipt by the target computing device of the first message, has been received by the instructing computing device.

45. The instructing computing device of claim 39, wherein the fourth message comprises an identification of the third message and at least one of:
an entry in a CoAP header; or
a CoAP option;
which is interpreted by the instructing computing device as indicating that the third message has been received by the target computing device.

46. The instructing computing device of claim 39, wherein the entry in the CoAP header comprises a value in a message type field.

47. The instructing computing device of claim 39, wherein the CoAP option comprises an option associated with the interpretation of the message by the instructing computing device or target computing device.

48. A target computing device operable to implement a Constrained Application Protocol (CoAP), the target computing device comprising processing circuitry configured to:
receive a first message from an instructing computing device, the first message comprising: i) a first message identifier, ii) a request, and ii) at least one of a) an entry in a CoAP header or a CoAP option, which is interpreted by the target computing device as requiring the target computing device to store a record of the first message;
responsive to receiving the first message:
i) store a record of the first message in a memory;
ii) send a second message to the instructing computing device, the second message confirming that the target computing device has received the first message and comprises an identification of the first message and at least one of a) an entry in a CoAP header or b) a CoAP option, which is interpreted by the instructing computing device as indicating that the first message has been received by the target computing device; and
iii) receive a third message from the instructing computing device, the third message comprising a second message identifier; and
responsive to receiving the third message:
i) update the record of the first message to indicate that the second message, confirming receipt by the target computing device of the first message, has been received by the instructing computing device; and
ii) send a fourth message to the instructing computing device, the fourth message confirming that the target computing device has received the third message.

49. The target computing device of claim 48, wherein the processing circuitry is further configured to, responsive to sending the second message:
start a second message timer; and
if the target computing device has not received the third message from the instructing computing device before expiry of the second message timer, update the record of the first message.

50. The target computing device of claim 48, wherein
the first message comprises a request, and
the processing circuity is further configured to, responsive to receiving the first message:
i) check whether or not a record of the first message is already stored in the memory;
ii) initiate fulfilment of the request from the first message in accordance with whether or not a record of the first message is already stored in the memory; and
iii) send the second message to the instructing computing device without storing a new record of the first message in the memory.

51. The target computing device of claim 48, wherein each of the first, second, third and fourth messages comprises a message token identifier having the same value.

52. The target computing device of claim 51, wherein the processing circuitry is further configured to:
include with the record of the first message that is stored in the memory the value of the message token identifier from the first message; and
use the value of the message token identifier from the third message to identity the record of the first message for updating.

53. The target computing device of claim 48, wherein the third message comprises at least one of:
an entry in a CoAP header; or
a CoAP option;
which is interpreted by the target computing device as requiring the target computing device to update its record of the first message to indicate that the second message, confirming receipt by the target computing device of the first message, has been received by the instructing computing device.

54. The target computing device of claim 48, wherein the fourth message comprises an identification of the third message and at least one of:
an entry in a CoAP header; or
a CoAP option;
which is interpreted by the instructing computing device as indicating that the third message has been received by the target computing device.

55. The target computing device of claim 48, wherein the entry in the CoAP header comprises a value in a message type field.

56. The target computing device of claim 48, wherein the CoAP option comprises an option associated with the interpretation of the message by the instructing computing device or target computing device.

57. A method performed by an instructing computing device operable to implement a Constrained Application Protocol (CoAP), the method comprising:
sending a first message to a target computing device, wherein the first message comprises a first message identifier and the first message is configured to cause the target computing device to store a record of the first message by including in the first message at least one of a) an entry in a CoAP header or b) a CoAP option, which is interpreted by the target computing device as requiring the target computing device to store a record of the first message;
storing a record of the first message in a memory;
receiving a second message from the target computing device, the second message confirming that the target computing device has received the first message and comprising an identification of the first message and at least one of a) an entry in a CoAP header or b) a CoAP option, which is interpreted by the instructing computing device as indicating that the first message has been received by the target computing device; and
responsive to receiving the second message:
i) updating the record of the first message to indicate that the first message has been received by the target computing device;
ii) sending a third message to the target computing device, the third message comprising a second message identifier, wherein the third message is configured to cause the target computing device to update its record of the first message to indicate that the second message, confirming receipt by the target computing device of the first message, has been received by the instructing computing device; and
iii) receiving a fourth message from the target computing device, the fourth message confirming that the target computing device has received the third message.

58. A method performed by a target computing device operable to implement a Constrained Application Protocol (CoAP), the method comprising:
receiving a first message from an instructing computing device, the first message comprising a first message identifier and a request and at least one of a) an entry in a CoAP header or a CoAP option, which is interpreted by the target computing device as requiring the target computing device to store a record of the first message; and
responsive to receiving the first message:
i) storing a record of the first message in a memory;
ii) sending a second message to the instructing computing device, the second message confirming that the target computing device has received the first message and comprises an identification of the first message and at least one of a) an entry in a CoAP header or b) a CoAP option, which is interpreted by the instructing computing device as indicating that the first message has been received by the target computing device; and
iii) receiving a third message from the instructing computing device, the third message comprising a second message identifier; and
responsive to receiving the third message:
i) updating the record of the first message to indicate that the second message, confirming receipt by the target computing device of the first message, has been received by the instructing computing device; and
ii) sending a fourth message to the instructing computing device, the fourth message confirming that the target computing device has received the third message.
